(19) United States
(12) Patent Application Publication
(10) Pub. No.: US 2026/0261221 A1
(43) Pub. Date: Sep. 3, 2026

(54) METHOD FOR OPERATING AN INVERTER, INVERTER, AND DOMESTIC APPLIANCE

(71) Applicant: BSH Hausgeräte GmbH, München (DE)

(72) Inventors: Markus HOSER, Aislingen (DE); Roman MAYER, Burgheim (DE)

(21) Appl. No.: 18/846,735

(22) PCT Filed: Mar. 31, 2023
(86) PCT No.: PCT/EP2023/058560

§ 371 Date: Sep. 13, 2024

(30) Foreign Application Priority Data
Apr. 6, 2022 (DE) 10 2022 203 427.9

(51) Int. Cl. H02P 21/22; H02P 21/12

(52) U.S. Cl. CPC H02P 21/22; H02P 21/12

(57) ABSTRACT

A method operates an inverter electrically connected to a stator winding of an AC voltage machine which drives a component that rotates temporarily about a rotational axis during operation. The inverter supplies an AC voltage to the stator winding, the AC voltage is provided by a series circuit of the inverter with two switching elements. The series circuit is supplied with an intermediate circuit DC voltage, and switch signals switch the switching elements. A controller ascertains the switch signals according to a pulse-width modulation principle based on a clock rate according to an operating signal for the component. A component operating rotational speed is determined based on the operating signal. The operating rotational speed is assigned an operating clock rate, the switch signals are determined based on the operating clock rate, the operating rotational speed of the component is set, and the switching elements are supplied with the switch signals.

The invention relates to a method for operating an inverter, to which a stator winding of an electrical AC voltage machine is electrically connected, which drives a component which rotates at least partially about an axis of rotation in an intended operation of a household appliance, the inverter applying an electrical AC voltage to the stator winding which is provided by means of at least one series circuit of the inverter having two switching elements, the series circuit being supplied with a DC-link voltage, switching signals for the switching elements being provided by means of a control unit of the inverter, the control unit controlling the switching signals according to a pulse width modulation principle based on a clock rate depending on an operating signal determined for the component, the clock rate being greater than a frequency corresponding to the rotational speed of the component. The invention further relates to an inverter for applying an electrical AC voltage to a stator winding of an electrical AC voltage machine, which is electrically connected to the inverter and which drives a component which rotates at least partially about an axis of rotation in an intended operation of a household appliance, with an electrical AC voltage, the inverter having at least one series circuit having two switching elements for providing the AC voltage and a control unit for providing switching signals for the switching elements, the series circuit capable of being supplied with a DC-link voltage, the control unit being designed to determine the switching signals according to a pulse width modulation principle based on a clock rate depending on an operating signal for the component, the clock rate being greater than a frequency corresponding to a rotational speed of the component. Finally, the invention also relates to a household appliance with a component which rotates at least intermittently about an axis of rotation in an intended operation of the household appliance, an electrical AC voltage machine which is rotationally coupled to the component for rotatably driving the component, the AC voltage machine having a stator winding, and an inverter electrically connected to the stator winding for supplying the stator winding with an electrical AC voltage.

Household appliances that have a component that rotates about an axis of rotation in an intended operation of the household appliance, inverters and methods for their operation are in principle extensively known in the prior art. Such household appliances are, for example, washing machines, tumble dryers, refrigerators, dishwashers or the like. For the intended operation thereof, these household appliances require rotatable devices which have at least one rotating component, for example in a household refrigeration appliance a drive shaft of a rotationally driven compressor, in particular without a gear ratio, in a washing machine a drive pin of a rotationally drivable washing drum, in particular in a washing machine with a gear ratio coupling the drive with the washing drum using a belt clutch, or the like. The rotatable component can be, for example, a drive shaft, a rotatably mounted pin, a belt slide or the like. In a compressor of a household refrigeration appliance, the rotatable component can be a drive shaft. As a rule, in such household appliances it is provided that the rotating component is rotatably driven in an intended operation by means of a rotor of an electrical AC voltage machine.

The electrical AC voltage machine is usually designed as a rotating or rotatable electrical machine and is also extensively known in the prior art, so that there is no need for separate printed evidence in this regard, just as for the household appliance. A rotating electrical machine is a device that converts electrical energy into mechanical energy, in particular rotational energy, in motor operation, and/or converts mechanical energy into electrical energy in generator operation. The movement is usually a rotary movement which is carried out by a rotor of the rotating electrical machine which is rotatably arranged relative to a stator of the rotating electrical machine. In contrast to the rotor, the stator is usually arranged in a rotationally fixed manner, that is, a rotary movement involves a rotational movement of the rotor relative to the stator. The rotor is arranged to be rotatable relative to the stator, with an air gap generally being formed between the rotor and the stator.

In intended operation, the stator and the rotor are linked by means of a magnetic flux, whereby the force effect or torque is provided in a motor operation, which drives the rotor to rotate relative to the stator. In generator operation, mechanical energy fed to the rotor is converted into electrical energy in the form of rotation in conjunction with torque. For this purpose, at least the stator has an electrical winding through which an electric current flows, also called a stator winding. The rotor can also have an electrical winding as a rotor winding and/or one or more permanent magnets.

For intended operation, the stator winding is supplied with AC voltage. Depending on the design of the electrical machine, in particular its stator winding, a single-phase or a multi-phase stator winding can be provided, which is accordingly supplied with a single-phase or multi-phase electrical AC voltage. A multi-phase AC voltage generally has phase AC voltages corresponding to the number of phases, which generally have approximately the same frequency and approximately the same amplitude, but are shifted relative to one another with regard to their phase position. A very common multi-phase AC voltage is, for example, a three-phase AC voltage in which the phase voltages are each shifted in phase by 120°. Such an AC voltage is also used, for example, in the public energy supply network.

In order to operate the AC voltage machine in such a way that the component can be rotated in the desired manner, the AC voltage machine, in particular its stator winding, is connected to an inverter. An inverter is a form of energy converter or energy transformer, by means of which electrical energy of a first form, for example a DC voltage, can be converted or transformed into electrical energy of a second form, namely an AC voltage. Nowadays inverters are usually used in the form of static energy converters or energy transformers, which means that, unlike dynamic energy converters or energy transformers, they do not have any mechanically movable, in particular rotatable, parts. Inverters of the generic type are designed as static energy converters or energy transformers, as a rule as switched-mode electronic energy converters or energy transformers, and for this purpose generally have at least one series circuit of two switching elements connected in series. The series circuit is connected to a DC link and is accordingly supplied with a DC-link voltage. The stator winding of the AC voltage machine is connected to a center tap of the series circuit.

The switching elements are supplied with switching signals that are provided by a control unit of the inverter or household appliance. The control unit determines the switching signals according to a pulse width modulation (PWM) principle based on a clock rate depending on an operating signal for the component. The operating signal can be provided by a higher-level control device of the household appliance and can, for example, indicate data or signal values relating to a rotational speed of the component, a torque and/or the like. The operating signal for the component is usually an electronic signal, which can be in the form of an analog and/or digital signal. The operating signal is provided, for example, by the higher-level control device, which is part of the household appliance and which can include an operating device by means of which the household appliance or its functions can be controlled or adjusted by a user.

The clock rate is usually significantly higher than a frequency corresponding to the rotational speed of the component. The stator winding is usually supplied with an AC voltage, which is essentially a rectangular AC voltage corresponding to the pulse width modulation. According to the pulse width modulation, an electrical current is established in the stator winding, so that in this way the function of the AC voltage machine and, as a result, also the drive function of the rotating component, can be adjusted. For this purpose, the control unit evaluates the operating signal for the component and determines for example the rotational speed, the torque and/or the like. Depending on this, the switching signals for the switching elements are then determined.

The pulse width modulation principle is known in principle in the prior art, for example from “Steuerverfahren für selbstgeführte Stromrichter” [“Control method for self-commutated current converters”] by Felix Jenni and Dieter Wuest, University publishing house at ETH Zurich, Stuttgart, Teubner, 1995, ISBN 3-519-06176-7, which is why detailed explanations of the pulse width modulation principle are omitted here. In this context, WO 2008/141407 A1 also discloses a method and a system for reducing electromagnetic interference in a cooling system.

Even if the state of the art is tried and tested, there are still disadvantages. On the one hand, using the inverter at a high clock rate limits the overall efficiency, among other things due to switching losses. At the same time, acoustic problems and problems relating to electromagnetic compatibility can occur, which can be perceived as disruptive by a user during intended operation.

The object of the invention is to improve the efficiency, the electromagnetic compatibility and/or the acoustics.

As a solution, the invention proposes a method, an inverter and a household appliance according to the independent claims.

Advantageous further developments result from features of the dependent claims.

With regard to a generic method, the invention proposes in particular that an operating rotational speed of the component to be set is determined depending on the operating signal, an operating clock rate is assigned to the operating rotational speed, the switching signals are determined based on the operating clock rate, the operating rotational speed of the component is set and the switching elements are supplied with the switching signals based on the operating clock rate either before or only after setting the operating rotational speed.

With regard to a generic inverter, the invention proposes in particular that the control unit is designed to determine an operating rotational speed of the component to be set depending on the operating signal, to assign an operating clock rate to the operating rotational speed, to determine the switching signals based on the operating clock rate, to set the operating rotational speed of the component and to apply the switching signals based on the operating clock rate to the switching elements either before or only after setting the operating rotational speed.

With regard to a generic household appliance, the invention proposes that the inverter is designed according to the invention.

The invention is based, among other things, on the idea that at least the efficiency, the electromagnetic compatibility, in particular with regard to conducted disturbance, or the acoustics can be improved by a suitable choice of the clock rate. It is therefore possible that the clock rate can be reduced, especially at a comparatively low rotational speed of the AC voltage machine, so that switching losses of the inverter can be reduced overall. This allows the efficiency to be improved. In addition, it is possible that when disruptive, acoustically perceptible noises occur, which can be detected, for example, by means of a suitable acoustic sensor, the clock rate is changed in such a way that, depending on this, a reduction in the disruptive acoustic noises can be achieved. Alternatively or additionally, an improvement in terms of electromagnetic compatibility can also be achieved. At a high operating rotational speed, on the other hand, the maximum operating clock rate does not need to be selected, but it can be adjusted accordingly to be smaller. The invention therefore creates a possibility of improving the efficiency and/or improving the acoustics. Of course, a combination can also be provided such that, for example, a clock rate can be reduced to improve the efficiency, especially in a partial load range in which a rotational speed of the AC voltage machine or the component is low, and at the same time the reduction in the clock rate can be selected so that at least the acoustics are not worsened. This can immediately have a positive impact on the overall lifespan of the household appliance as well as on the electromagnetic compatibility, for example, in relation to conducted disturbance, as defined in standard EN 61000. The varying or changing of the operating clock rate is therefore preferably carried out essentially outside of dynamic processes in relation to the rotational speed of the component, such as acceleration, braking and/or the like. In addition, with regard to determining the assigned operating clock rate, further parameters can also be taken into account, such as a temperature of the inverter, in particular its switching elements, a current value of the DC-link voltage to which the inverter is electrically coupled, and/or the like. It can thus be provided that the operating clock rate is lower at a high temperature than at a low temperature. Furthermore, it can be provided that the operating clock rate is lower for a high DC-link voltage than with a low DC-link voltage.

The set operating rotational speed is a target rotational speed of the rotor of the AC voltage machine or the component. The operating clock rate is preferably not changed or varied while the set operating rotational speed is being reached. This means that the assignment of the operating clock rate preferably takes place either before the operating rotational speed is set, in particular before the process of setting the operating rotational speed is started, or only when the set operating rotational speed is reached.

According to the invention, for example, an operating rotational speed to be set for the component is first determined depending on the operating signal. For this purpose, the control unit can evaluate the operating signal accordingly and determine the operating rotational speed to be set. Once the operating rotational speed has been determined, an operating clock rate can be assigned to it, for example by assigning an operating clock rate to the operating rotational speed using a table. Of course, functional relationships can also be used to be able to calculate the operating clock rate, for example based on the operating rotational speed. For this purpose, the control unit can, for example, have a program-controlled computer unit which uses a computer program to calculate the operating clock rate depending on the operating rotational speed as part of the assignment. As soon as the operating clock rate has been assigned by the control unit, the switching signals can be based on this using the pulse width modulation principle. The operating rotational speed of the component is then set using the control unit. For this purpose the inverter, that is, in particular, its switching elements, is controlled accordingly so that the component assumes the operating rotational speed. The switching signals determined on the basis of the operating clock rate do not yet need to be applied during the period determined in this way. Only thereafter are the switching signals based on the operating clock rate applied to the switching elements.

This has, among other things, the advantage that the method according to the invention enables a high level of stability in intended operation, so that not only the reliability but also the service life can be increased. This proves to be particularly advantageous compared to WO 2008/141407 A1, in which a continuous change in the clock rate is provided for. As already explained, however, there is a particular problem here with regard to stability during intended operation, which is why the teaching of WO 2008/141407 A1 is particularly unsuitable for household appliances for which a high level of reliability and safety is required.

The invention is particularly suitable, among other things, for use in refrigerators for household use. However, it is not limited to this application and can of course also be used in almost any other household appliances that have rotatable components that are to be driven by an AC voltage machine. The invention is particularly suitable even if the component to be driven essentially does not provide a uniform, in particular constant, torque. The invention makes it possible to take into account torque fluctuations, such as those that can occur, for example, in a reciprocating piston compressor of a refrigeration appliance, for the intended operation, as will be explained further below.

The AC voltage machine is an electrical machine, in particular a rotating electrical machine, to which AC voltage is applied during the intended operation. This AC voltage is provided by the inverter, with the AC voltage being provided depending on the operating signal for the component, so that the component can be operated in a desired operating state by means of the operating signal. For this purpose, the inverter in turn is connected to a DC link or it comprises such a DC link, to which the at least one series circuit consisting of the two switching elements is preferably also connected. The DC link provides a DC-link voltage that is converted or transformed into the AC voltage by means of the inverter. The inverter thus creates an electrical coupling between the DC link and the stator winding of the electrical AC voltage machine.

In order to be able to implement the desired energy conversion or energy transformation using the inverter, the switching elements of the at least one series circuit are operated in a predetermined switching mode.

A switching element or an electronic switching element, in particular a semiconductor switch, in the sense of this disclosure is a preferably controllable electronic switching element, for example a transistor, a thyristor, combination circuits thereof, in particular with parallel-connected freewheeling diodes, for example a metal oxide semiconductor field effect transistor (MOSFET), an insulated gate bipolar transistor (IGBT), preferably with integrated freewheeling diodes, or the like. The switching element is operated in switching mode.

The switching operation of the semiconductor switch in the form of a transistor means that in a switched-on switching state a very low electrical resistance is provided between the connections of the transistor forming the switching path, so that a high current flow is possible with a very low residual voltage. In the switched-off switching state, the switching path of the transistor has a high resistance, that is, it provides a high electrical resistance, so that even with a high voltage applied to the switching path, there is essentially no or only a very low, in particular negligible, current flow. This differs from linear operation with transistors.

The DC link can be electrically coupled to a DC voltage source to provide an electrical energy supply. However, it is frequently also provided that the DC link is connected to an AC voltage network, for example a public energy supply network or the like, via a further energy converter or energy transformer. The energy converter or energy transformer required for this can convert an AC voltage into a DC voltage for this purpose, as can be achieved, for example, by means of a rectifier unit or the like.

If the stator winding is designed for multi-phase operation, the inverter is usually designed accordingly and can, for example, have at least one respective series circuit of two switching elements to provide a respective phase AC voltage. Depending on the circuit topology, however, it can also be provided that for each phase AC voltage at least two corresponding series circuits are connected in parallel and coupled to the DC link. The switching elements can be operated in a complementary manner, the stator winding or the corresponding phase of the stator winding being connected between the two series circuits, namely their respective center taps. Of course, other combinations can also be provided. All series circuits are preferably connected in parallel and electrically coupled to the DC link.

The clock rate, on the basis of which the switching signals are provided according to the pulse width modulation principle, is preferably at least twice as large as the frequency corresponding to the rotational speed of the component. However, the clock rate is often at least five to ten times, for example 40 times, as large as the frequency corresponding to the rotational speed of the component. In the prior art, which generally does not provide for a significant change in the clock rate during intended operation, the clock rate is therefore selected in relation to the frequency corresponding to the maximum rotational speed of the component.

The changing of the clock rate according to the invention is preferably carried out in two phases, namely in that in a first phase the operating rotational speed of the component to be set is first determined depending on the operating signal, the operating rotational speed is assigned to the operating clock rate, the switching signals are determined based on the operating clock rate and the operating rotational speed of the component is set. Thereafter, in a second phase, in particular when the component has reached the operating rotational speed, the switching elements can be supplied with the switching signals based on the operating clock rate. Alternatively, it can also be provided that the second phase is carried out before the operating rotational speed is set. The invention therefore avoids making changes to the operating clock rate at the same time, particularly when the operating state of the component changes, such as changing the operating rotational speed. As a result, a high level of stability and reliability of the method can be achieved with the invention. At the same time, the invention makes it possible to detect acoustic effects and, if necessary, to intervene with a modified first phase in order to improve the acoustics. Changing the operating clock rate can take place over a predetermined period of several operating clock cycles. However, it can also be provided that the operating clock rate is switched at a predetermined time, which is determined by the control unit.

The operating rotational speed is a rotational speed of the component that is to be set for a desired operating state of the component to be set. This operating state can be specified by the operating signal via the control device of the household appliance. The control unit determines the operating clock rate depending on the operating signal or the operating rotational speed that is to be set and assigns this to the operating rotational speed that is to be set. This can take place by, for example, calculating the appropriate operating clock rate as part of the assignment based on an operating rotational speed value for the component based on the functional relationship. This can be a single value that can be individually assigned to the respective operating rotational speed. However, it can also be provided that one is selected from a plurality of possible operating clock rates that can be assigned to this operating rotational speed. Depending on other circumstances, provision can be made for the operating clock rate to be reassigned, for example if acoustic disturbances or the like occur. It can also be provided that the operating clock rate is determined using an assignment table. Based on this, the control unit determines the switching signals using the pulse width modulation principle. As soon as the operating rotational speed of the component is set to the operating rotational speed to be set, the control unit can apply the switching signals based on this operating clock rate to the switching elements of the inverter. This changes the operating clock rate.

The control unit is preferably designed as an electronic hardware circuit and can have a program-controlled computer unit in order to implement the desired functionality. Of course, the control unit can also be formed solely by the computer unit or can also have a combination of a hardware circuit with the computer unit. In principle, however, there is also the possibility that the control unit exclusively comprises a hardware circuit. The higher-level control device of the household appliance can also be at least partially comprised of the control unit. However, it can also be provided as a separate component in the household appliance. In particular, it is at least partially provided as a component of the inverter.

According to an advantageous development, it is proposed that a maximum operating clock rate or an operating clock rate dependent on the operating rotational speed to be set is set during an acceleration process of the component. This has the advantage that the acceleration process of the component can be carried out with a high degree of reliability and essentially free of faults. The maximum operating clock rate means that a maximum operating rotational speed of the component can also be achieved reliably and without problems. Of course, it may be sufficient to select the operating clock rate depending on the operating rotational speed to be set. Then the maximum operating clock rate does not need to be selected, which can result in further advantages especially with regard to the switching losses of the inverter. The maximum operating clock rate or the operating clock rate dependent on the operating rotational speed to be set is preferably set at least briefly for the beginning or at the beginning of the acceleration process.

A further development proposes that the operating clock rate set before the braking process is maintained during a braking process of the component. This can also improve the stability and reliability of the method during intended operation. However, the maximum operating clock rate does not need to be set during the braking process, especially since during a braking process it can be assumed that the operating rotational speed decreases over time. The operating clock rate set immediately before the braking process is therefore usually sufficient to reliably implement a reduced operating rotational speed of the component.

Furthermore, it is proposed that after the acceleration process or the braking process has ended, the operating clock rate is set depending on the current operating rotational speed. This development makes it possible to further improve the method according to the invention by adjusting the operating clock rate, adapted to the current operating rotational speed reached after the acceleration process or the braking process, to the then existing operating rotational speed. For this purpose, the previously explained method according to the invention can be carried out again, preferably according to the two phases described above.

According to a further development, it is proposed that the operating clock rate is determined linearly depending on the operating rotational speed. In this embodiment it is provided that the operating clock rate can be determined via a constant factor proportional to the operating rotational speed. This enables a particularly simple determination of the operating clock rate depending on the operating rotational speed to be set.

In addition, it is proposed that an integer ratio is chosen between the operating clock rate and the operating rotational speed. As a result, the calculation or determination of the operating clock rate can be further simplified or improved. This embodiment can be implemented particularly easily at a later date in existing control units. In addition, advantageous effects in terms of electromagnetic compatibility can be achieved.

Furthermore, it is proposed that the operating clock rate be changed depending on a mechanical rotor position of a rotor of the electrical AC voltage machine. This allows account to be taken of technical machine characteristics, in particular with regard to torque provision of the AC voltage machine, a torque load on the AC voltage machine by the driven component and/or the like. For this purpose, it can be provided that the control unit has suitable sensors, for example rotary position sensors or the like, or is connected to such sensors and/or a corresponding rotor position is determined from electrical parameters of the stator winding.

In addition, it is proposed that the component has a reciprocating piston compressor and that the operating clock rate is changed outside of a compression stroke. This development has the advantage that the stability can be improved when shifting the operating clock rate or when changing the operating clock rate. In addition, greater power can be provided by the inverter or greater torque by the AC voltage machine during a compression stroke, as a result of which unfavorable dynamic processes can occur in the inverter due to the change in the operating clock rate. By changing the operating clock rate outside of the compression stroke, the disadvantages and problems that would otherwise occur can be avoided.

According to a further development, it is proposed that the operating clock rate is swept. Sweeping means the provision of oscillations, in particular harmonic oscillations such as sine oscillations, with a frequency of these oscillations being varied cyclically between two predeterminable end values of the frequency. In this way a reduction in acoustic disturbances can be achieved. In addition, this further development makes it possible to improve electromagnetic compatibility, especially with regard to conducted disturbance, as explained above. Interference energy can be distributed over a wider frequency spectrum, which improves overall compliance with interference limits and reduces interference suppression efforts. The acoustics can also be improved in this way.

It is preferably provided that the sweeping covers a frequency range in which a maximum frequency value is at least approximately 10%, preferably approximately 20%, particularly preferably approximately 30%, greater than the assigned operating clock rate and/or a minimum frequency value is at least approximately 10%, preferably approximately 20%, particularly preferably approximately 30%, smaller than the assigned operating clock rate. It has been shown that sweeping in this area proves to be particularly beneficial in order to improve acoustics and/or electromagnetic compatibility, especially with regard to improving conducted disturbance. Sweeping can be achieved using the control unit by varying the operating clock rate accordingly. For sweeping, it can be provided that the variation between the maximum frequency value and the minimum frequency value takes place according to a predetermined characteristic and/or in a predetermined sweeping period. For example, sweeping can be determined based on a functional relationship, as will be explained in more detail below. The sweeping can take place, for example, with a sweeping frequency that is smaller than the operating clock rate. Accordingly, the sweeping period is longer than a period of the operating clock rate that is to be swept.

According to a development, it is proposed that the component has a reciprocating piston compressor and the sweeping is synchronized with a compression process of the reciprocating piston compressor. This allows performance fluctuations that occur due to the intended operation of the reciprocating piston compressor to be taken into account, especially when sweeping, and thus not only to improve the acoustics but also, if necessary, the electromagnetic compatibility. For example, it can be provided that the sweeping is essentially only carried out during a compression process in which greater power provision by the inverter is required. However, the invention is not limited to this. Other processes can also be provided that can be synchronized with sweeping. For example, it can also be provided that a sweeping amplitude of the sweeping, that is, a frequency difference between the maximum frequency value or the minimum frequency value and the average operating clock rate, is changed, in particular depending on properties of the component, as in the case of the reciprocating piston compressor.

Furthermore, it is proposed that the sweeping takes place depending on a rotational position of the reciprocating piston compressor. In addition to an amplitude of the sweeping, the dependency can also take into account the rotational position of the reciprocating piston compressor in such a way that the sweeping is activated at the start of a compression process or the sweeping amplitude is increased and the compression process is ended or is reduced in relation to the amplitude. Other embodiments can also be implemented from a professional perspective.

With regard to the inverter according to the invention, it is proposed in particular that the stator winding is designed as a multi-phase stator winding and the inverter is designed to operate the multi-phase stator winding. As already explained above, the particularly favorable properties that a three-phase stator winding in particular allows can also be made usable for the invention.

The advantages and effects specified for the method according to the invention also apply equally to the inverter according to the invention and the household appliance equipped with the inverter according to the invention and vice versa. In particular, method features can therefore also be formulated as device features and vice versa.

Further features of the invention emerge from the claims, the figures and the description of the figures. The features and combinations of features mentioned above in the description and the features mentioned below in the description of the figures and/or merely shown in the figures may be used not only in the combination indicated in each case but also in other combinations or alone, without going beyond the scope of the invention. Embodiments of the invention which are not explicitly shown in the figures and described but which proceed from separate combinations of features from the described embodiments and can be produced are therefore also considered to be included and disclosed. Embodiments and combinations of features are also to be regarded as disclosed, which thus do not have all the features of an originally formulated independent claim. In addition, embodiments and combinations of features, in particular through the statements set out above, are to be regarded as disclosed, which go beyond or deviate from the combinations of features set out in the references to the claims.

In the figures:

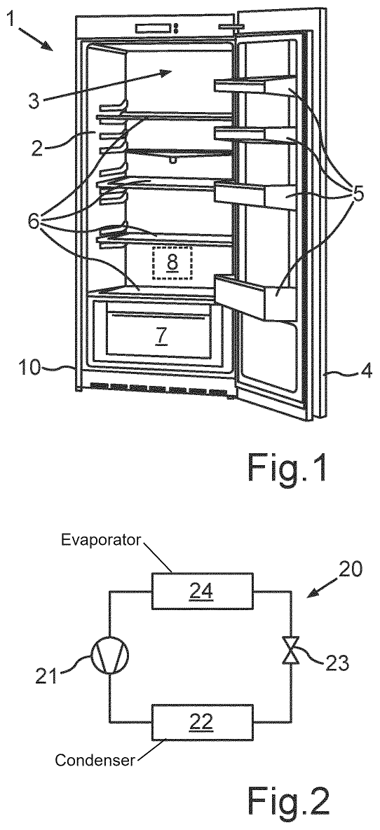

FIG. 1 shows a household refrigeration appliance in a schematic perspective representation;

FIG. 2 shows a schematic representation of a refrigerant circuit of the household refrigeration appliance having a reciprocating piston compressor;

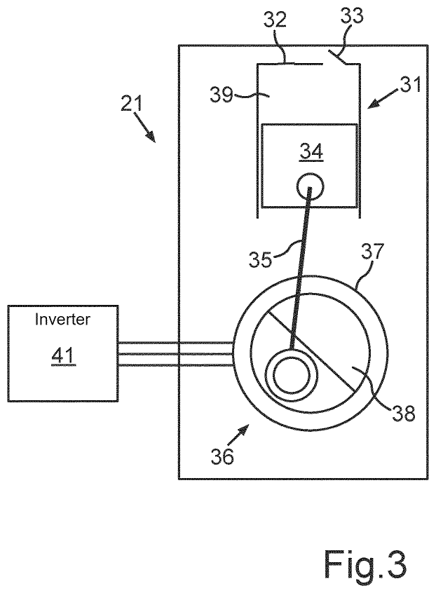

FIG. 3 shows a schematic view of the reciprocating piston compressor, which is driven by a three-phase AC voltage machine connected to an inverter;

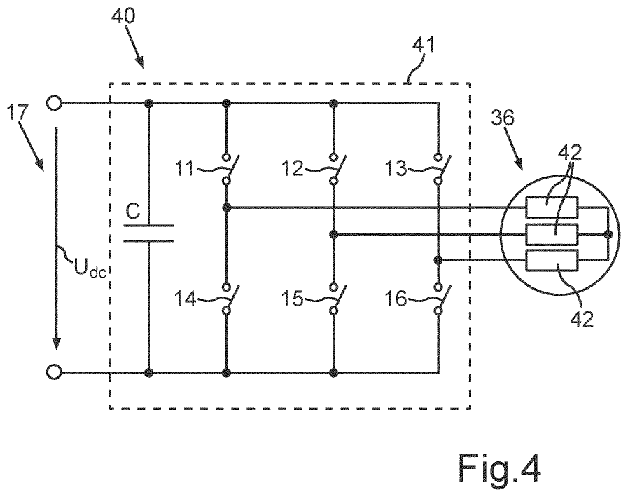

FIG. 4 shows a schematic circuit diagram representation of an electrical energy supply for the inverter, which is designed as a three-phase inverter, with three phase windings of a stator winding of the AC voltage machine being connected to the inverter;

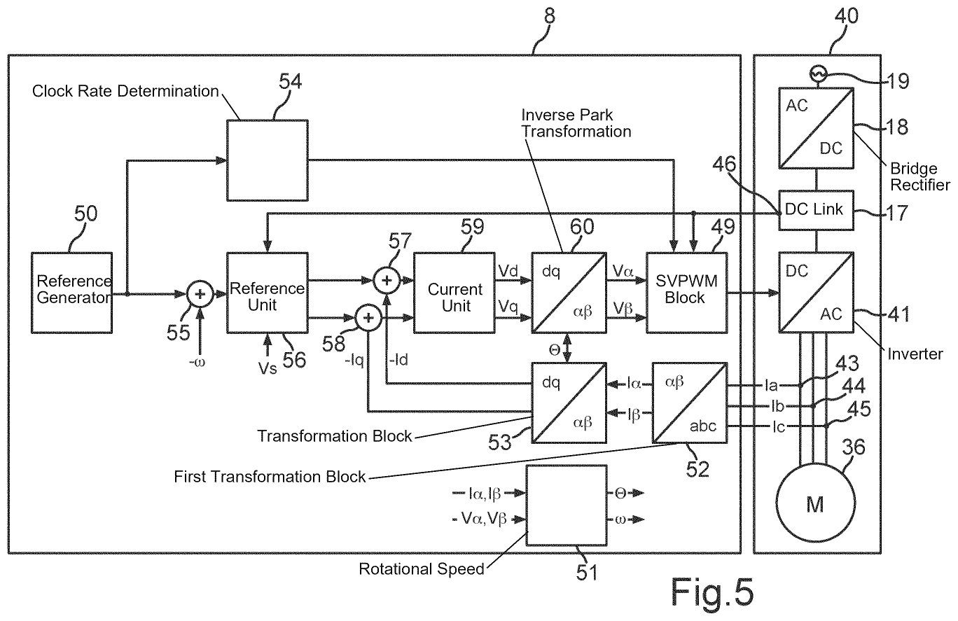

FIG. 5 shows a schematic block diagram representation of a section of a control device of the household appliance, in particular for the inverter;

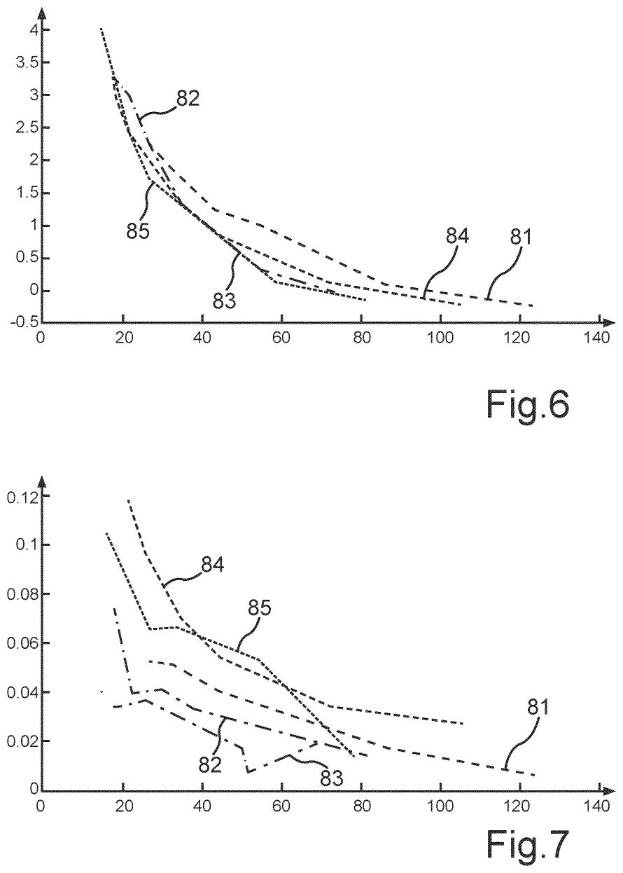

FIG. 6 shows a schematic diagram representation of a differential efficiency performance diagram for an effect of the operation of the inverter when using a variable clock rate depending on an input power;

FIG. 7 shows a schematic diagram representation of a differential performance coefficient performance diagram to illustrate an improved effect of the operation of the household appliance when using a variable clock rate depending on an input power;

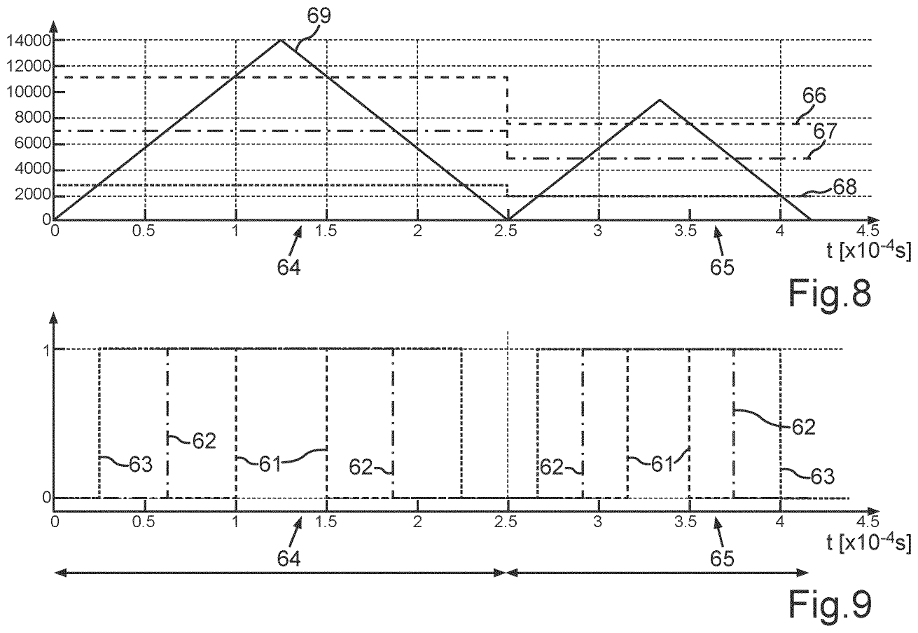

FIG. 8 shows a schematic diagram representation of the generation of phase control signals for determining switching signals for switching elements of the inverter;

FIG. 9 shows a schematic diagram representation of the phase control signals determined based on FIGS. 8, and

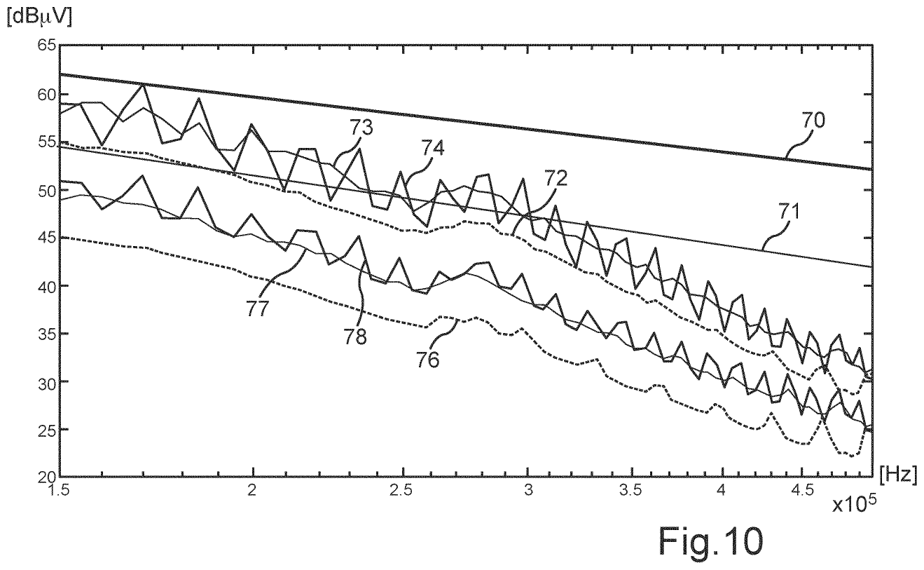

FIG. 10 shows a schematic diagram representation of conducted disturbance in the energy supply in different operating states.

FIG. 1 shows a schematic perspective representation of a household refrigeration appliance 1, which includes a heat-insulated carcass 10 with an inner container 2, which delimits a coolable interior 3. The coolable interior 3 is intended for storing foods (not shown in detail).

In the present exemplary embodiment, the household refrigeration appliance 1 has a pivoting door 4 for closing the coolable interior 3. The door 4 is pivotally mounted with respect to a vertical axis. When the door 4 is open, as shown in FIG. 1, the coolable interior 3 is accessible from the outside. On the side of the door 4 facing the coolable interior 3, several door racks 5 are arranged for storing food. In the coolable interior 3, several shelves 6 are arranged for storing food, and in the lower area of the coolable interior 3, a drawer 7 is arranged, in which food can also be stored.

The household refrigeration appliance 1 includes a refrigerant circuit 20 shown in FIG. 2 for cooling the coolable interior 3. In the present exemplary embodiment, the refrigerant circuit 20 comprises a refrigerant not shown in detail, a reciprocating piston compressor 21, a condenser 22 connected downstream of the reciprocating piston compressor 21, a flow restrictor 23 connected downstream of the condenser 22, which in the present case is designed as a restrictor or capillary tube, and an evaporator 24, which is arranged between the flow restrictor 23 and the reciprocating piston compressor 21. The reciprocating piston compressor 21 is arranged within a machine space, not shown, of the household refrigeration appliance 1, which is located behind the drawer 7. The reciprocating piston compressor 21 is shown in more detail in FIG. 3.

FIG. 3 shows a schematic representation of the reciprocating piston compressor 21. The reciprocating piston compressor 21 comprises a compressor chamber with an inlet 32 and an outlet 33 for the refrigerant, and a piston 34 displaceably mounted within the compressor chamber 31. The inlet 32 and the outlet 33 are each provided with appropriate valves, as is generally known to the person skilled in the art.

The reciprocating piston compressor 21 also has a connecting rod 35, which is connected at one end to the piston 34 and at the opposite other end to an eccentric disk arranged on the rotor 38 as a rotating component. The rotor 38 is part of an AC voltage machine 36 of the household refrigeration appliance 1. The AC voltage machine 36 is in the present case designed as a three-phase permanently excited synchronous machine.

The AC voltage machine 36 has a stator 37 and the rotor 38 which is rotatably mounted relative to the stator 37. The connecting rod 35 is coupled to the rotor 38 via the eccentric disk, so that during intended operation of the household refrigeration appliance 1, when cooling power is to be provided, the piston 34 uses the AC voltage machine 36 to create a volume 39 enclosed by the compressor chamber 31 and the piston 34 for compressing the refrigerant able to change cyclically.

The household refrigeration appliance 1 also has an electronic control device 8 (FIG. 1), which is set up to operate the refrigerant circuit 20 in such a way that the coolable interior 3 reaches at least approximately a predetermined or predeterminable target temperature. The electronic control device 8 is set up in such a way that it detects a current temperature of the interior 3 using a temperature sensor (not shown), compares it with the predetermined or predeterminable target temperature and emits at least one control signal depending on the comparison.

In order to be able to operate the refrigerant circuit 20, the household refrigeration appliance 1 in the case of the present exemplary embodiment has an electrical energy supply 40 (FIG. 4), which, in addition to a DC link 17, has the electrical inverter 41, which has three series circuits each consisting of two switching elements 11, 12, 13, 14, 15, 16, which are connected in parallel to the DC link 17. On the inverter side, a capacitor C is also provided, which is connected in parallel to the series circuits.

In the present case, the switching elements 11, 12, 13, 14, 15, 16 are MOSFETs that are operated in switching mode. Alternatively, other transistors such as IGBTs or the like can of course be used instead of MOSFETs. For this purpose, gate connections of the MOSFET are connected as control connections of the switching elements 11, 12, 13, 14, 15, 16 to the electronic control device 8 and from the electronic control device 8 respective switching signals are applied as a control signal. Respective phase windings 42 of a stator winding of the stator 37 of the AC voltage machine 36 are connected to respective central connections of the series circuits, so that in the present case a star connection is provided. The DC link 17 is supplied with electrical energy from a public energy supply network 19 via a bridge rectifier 18 (FIG. 5).

FIG. 5 shows a schematic block diagram representation of a section of the control device 8, which in the present case is part of the inverter 41. In principle, however, the control device 8 can also be designed separately from the inverter and at least partially form the control device of the household appliance 1. FIG. 5 shows schematically the part of the control device 8 which serves to provide the switching signals for the switching elements 11, 12, 13, 14, 15, 16, so that the inverter 41 is able to provide a three-phase AC voltage for the phase windings 42 of the AC voltage machine 36.

From FIG. 5 it can also be seen that the inverter 41 is connected on the DC voltage side to the DC link 17 of the power supply 40. The DC link 17 provides a DC-link voltage U_{dc}, with which the inverter 41, in particular its series circuits made up of the switching elements 11 to 16, is supplied with electrical energy. The DC link 17 is also connected to the bridge rectifier 18, which in turn is connected on the AC voltage side to the public energy supply network 19, which in the present case provides a single-phase electrical AC voltage with an RMS value of approximately 230 V at a frequency of approximately 50 Hz.

In this embodiment, the control device 8 is based on vector control, but the invention is not limited to this. Vector control is generally known to the person skilled in the art, so detailed explanations are not provided here.

The control device 8 is also connected to current sensors 43, 44, 45, with which respective phase currents of the phase windings 42 of the stator winding can be detected. Furthermore, the control device 8 is connected to the switching elements 11 to 16, so that the control device 8 can apply the respectively assigned switching signal to them. Finally, the DC-link voltage U_{dc} of the DC link 17 is detected by means of a voltage sensor 46. The voltage sensor 46 is also connected to the control device 8.

The electrical phase currents of the respective phase windings 42 detected by the current sensors 43 to 45 are fed to a first transformation block 52 of the control device 8, which calculates transformation values Iα, Iβ as transformed current variables using a Clarke transformation from the measured current values of the current sensors 43 to 45. Here, multi-phase variables, such as the measured current values of the current sensors 43 to 45, are converted into a simpler two-axis coordinate system with the axes α, β, so that the transformation values Iα, Iβ can be determined. In this way, the transformation block 52 provides the transformation values Iα and Iβ.

The transformation values Iα, Iβ are then fed to blocks 51 and 53. The block 51 implements an observation function and provides a rotational speed signal w as well as a signal for a current rotational position ⊖ of the rotor of the AC voltage machine 36. For this purpose, block 51 receives further signals Va and Vβ, which will be explained below. The rotational position ⊖ determined in block 51 is further fed together with the transformation values Iα and Iβ to the transformation block 53, which carries out a d/q transformation, also referred to as a Park transformation, and determines transformation values Iq and Id from this.

Block 50 denotes a reference generator that provides a target rotational speed for the AC voltage machine 36, namely its rotor 38. The block 50 is part of a higher-level control that, among other things, specifies a target rotational speed for the rotor 38. A comparator 55 determines a difference between the target rotational speed of block 50 and the rotational speed ω determined by block 51.

This difference is fed to a reference unit 56, as is the DC-link voltage U_{dc} determined by means of the voltage sensor 46 and a vector Vs. From this, the reference unit 56 determines transformation target values for Id and Iq. These transformation target values are compared by further comparators 57, 58 with the transformation values Iq and Id determined by block 53 and the differences determined here are fed to a current unit according to block 59. The current unit according to block 59 determines vectors Vd and Vq, which are fed to an inverse Park transformation in a block 60, which determines vectors Va and VP taking into account the rotational position ⊖ determined by block 51. The vectors Va and Vβ are fed to a SVPWM-Block 49. The SVPWM block 49 receives the switching signals for the switching elements 11 to 16, taking into account the DC-link voltage U_{dc} determined by the voltage sensor 46 and a clock rate signal explained below, and provides these for the intended operation.

A clock rate determination block 54 also receives the rotational speed signal w from block 50 in relation to the target value for the rotational speed and uses this to determine an operating clock rate, as will be explained below. Block 54 then provides a clock rate signal for SVPWM block 49, which determines the switching signals for switching elements 11 to 16 based on the clock rate signal. The block 54 serves to optimize the switching behavior of the inverter 41 and its switching elements 11 to 16. The control device 8 explained with reference to

FIG. 5 allows the operating clock rate or operating clock frequency, also called the carrier frequency, to be varied in order to increase the efficiency of the inverter 41 and of the household refrigeration appliance 1. Even if the invention is explained below with reference to the household refrigeration appliance 1, it is not limited to this and can also be used in other household appliances, such as washing machines, tumble dryers and the like.

The invention therefore differs from the prior art in that, among other things, the operating clock rate no longer needs to be constant during intended operation of the household refrigeration appliance. As a result, the operating clock rate can be selected depending, among other things, on the rotational speed of the rotor 38 of the AC voltage machine 36 so that not only switching losses of the switching elements 11 to 16 but also acoustic disturbances can be reduced.

The clock rate unit 54 determines the operating clock rate that should be used for the target rotational speed based on the target rotational speed of the block 50. The operating clock rate determined in this way is transmitted to the SVPWM block 49, which, based on this, provides the switching signals for the switching elements 11 to 16.

Even if the switching elements 11 to 16 are formed by MOSFETs in the present case, other transistors can of course also be used in alternative embodiments, for example bipolar transistors or the like.

With the block 50, an operating rotational speed to be set for the reciprocating piston compressor 21 is specified or determined as a target rotational speed depending on an operating signal (not shown). The operating rotational speed is then assigned to the operating clock rate. This can be implemented, for example, as follows:

At a constant clock rate f_{PWM} the resolution of a rotor angle Δφ of the rotor results in the following relationship according to Formula 1:

$$Δφ = 2 π \frac{{f}_{Motor} \cdot p}{{f}_{PWM}}$$

Here f_{Motor} corresponds to a frequency corresponding to the rotational speed of the rotor. This means that the resolution of the rotor angle and the number of cycles per revolution of the rotor 38 are dependent on the rotor frequency f_{Motor}, the clock rate f_{PWM} and a number of pole pairs p of the AC voltage machine 36. An increased resolution of the rotor angle leads to an increased resolution of the AC voltage provided by the inverter 36, which at the same time also forms a manipulated variable for the regulation according to the control device 8. It follows that at a constant clock rate, the resolution and also the control quality increase at low rotational speeds of the rotor 38. In this context the control quality can, for example, be evaluated in terms of distortion current and torque ripple. A degree of modulation in relation to the pulse width modulation can thus be adapted by the control device 8 to a currently existing operating state, for example in relation to a rotational speed, a torque and an available DC-link voltage and/or possibly others.

With the invention it is now possible to achieve a substantially constant resolution of the rotor angle Δφ. This can be achieved by adjusting the clock rate to the rotor frequency corresponding to the rotor rotational speed, as shown by the following Formula 2:

$${f}_{PWM} = 2 π \frac{{f}_{Motor} \cdot p}{Δφ}$$

A constant number of operations r can be assigned to this clock rate, as can be seen from the following Formula 3:

$$r = \frac{{f}_{PWM}}{{f}_{Motor} \cdot p}$$

If the number of operations is an integer, this can also be referred to as synchronous modulation.

The resolution of the rotor angle Δφ can thus be selected depending on a maximum value of the rotor rotational speed, the clock rate, an execution time for the control, a permissible distortion current or a permissible torque ripple and/or an accuracy of the observer system according to block 51. By choosing a constant number of operations, a reduction in the clock rate can be achieved, especially at low rotational speeds of the rotor 38. Due to the constant resolution of the rotor angle Δφ, a high level of efficiency can still be achieved with respect to the AC voltage machine 36.

What is not shown in the figures is that the control device 8 has a computer unit which is controlled in terms of its functionality by means of a computer program and which implements the previously described functions. In detail, the functionality of the method can preferably be implemented as follows:
1. First, the clock rate is determined according to Formula 2.
2. An implementation strategy is specified, for example by determining a suitable point in time to change the clock rate. The point in time is preferably selected when the rotor 38 has reached a predetermined rotational speed. In order to be able to achieve the highest possible stability, the clock rate should preferably not be carried out when starting a cooling process, when stopping a cooling process, when accelerating or braking and/or during a compression process of the reciprocating piston compressor. In the present embodiment, these processes are therefore preferably carried out with a suitable, essentially constant operating clock rate. With regard to a starting process, this means that in the present embodiment it is provided that the changing of the operating clock rate is only carried out after the target rotational speed of the rotor 38 has been reached. If a dynamic process such as acceleration or braking is intended, these can preferably be differentiated. During an acceleration, in which the rotational speed of the rotor 38 also increases, the operating clock rate is changed before the acceleration process to a maximum operating clock rate or to an operating clock rate that corresponds to the operating rotational speed to be set. In the case of a braking process that corresponds to a reduction in the rotational speed of the rotor 38, it is preferably provided that the operating clock rate is only changed when the target rotational speed or the operating rotational speed to be set has been reached. In addition, it can be taken into account that changing the operating clock rate only takes place in a predetermined range of a mechanical rotor position. This makes it possible to avoid changing the operating clock rate, for example during a compression process of the reciprocating piston compressor 21.
3. The control parameters of the, preferably vector-based, control unit 8 are determined based on the operating clock rate that is to be set.
4. The operating clock rate is then activated in accordance with number 1 above at the time determined in number 2. Account can also be taken of the fact that the change in the operating clock rate only takes place at the end of a current, completed period of the current operating clock rate. In this context, it should be noted that changing the operating clock rate in the present case has no influence on a dead time in relation to the respective switching elements of a respective series circuit.
5. At the same time, the corresponding parameters, in particular with regard to the regulation, will also be adjusted or updated accordingly at the time described in number 4.

In this way, it is possible to change or adapt the operating clock rate as needed, so that the efficiency of the inverter 36 and thus also that of the household refrigeration appliance 1 can be improved.

At the same time, an improvement in the acoustics can also be achieved in this way. It is possible to record corresponding acoustic signals using an acoustic sensor (not shown in the figures) and to take these into account when determining the operating clock rate. This also makes it possible to achieve an improvement in terms of the acoustic properties of the household refrigeration appliance 1.

The effect of the invention can be seen from the schematic diagram representations in FIGS. 6 and 7. FIG. 6 shows a schematic diagram representation in which an abscissa corresponds to an electrical power in W fed to the inverter 41. An ordinate is assigned to a difference in the efficiency of the inverter of a clock rate variation according to the invention to a constant operating clock rate in %. Graphs 81 to 85 are assigned to respective operating temperature conditions on the reciprocating piston compressor 21, as follows:

Graph 81 corresponds to a temperature on a pressure side of 55° C. and a temperature of −10° C. on a suction side. Graph 82 differs from graph 81 in that there is a temperature of −25° C. on the suction side. Graph 83 differs from graph 81 in that there is a temperature of −30° C. on the suction side. In graph 84, the temperature on the pressure side is 35° C., whereas the temperature on the suction side is −10° C. In graph 85, the temperature on the pressure side is also 26 35° C., whereas the temperature on the suction side is −25° C. It can be seen that the method according to the invention has a positive effect in terms of efficiency, particularly in the partial load range. With regard to the graph 81, an improvement already occurs at a power of approximately 100 W or less. With regard to the graph 84, an improvement already occurs at a power of approximately 82 W or less. In graphs 82 to 85, the improvement occurs at a power of approximately 70 W or less. The smaller the power becomes, the greater the advantage according to the invention becomes.

FIG. 7 shows a corresponding schematic diagram representation for the efficiency of the household refrigeration appliance 1, where the abscissa is chosen as in FIG. 6 and the ordinate here corresponds to a difference of a coefficient of performance (COP) of a clock rate variation according to the invention to a constant operating clock rate in %. With regard to the boundary conditions, the graphs correspond to those already explained with reference to FIG. 6, for which reason reference is made to the corresponding statements. Here, too, it can be seen that an improvement in efficiency can be achieved, particularly in the partial load range.

The control device 8 generates control signals for determining the switching signals for the switching elements 11 to 16, as explained in addition in the following with reference to FIGS. 8 and 9. FIG. 8 shows a schematic diagram representation in which an abscissa corresponds to the time in seconds and an ordinate corresponds to counter readings of counters in the computer unit (not shown) of the control device 8. It can be seen that in a first period 64, which extends from point in time t=0 to point in time t=2.5·10⁻⁴ s, a counter reading of a counter unit of the control device 8 for a first triangular signal 69 starting at point in time t=0 is incremented from a counter value=0 up to a counter value of 14000. This value is reached at point in time t=1.25·10⁻⁴ s. As soon as this counter reading is reached, the counter is counted down again until the counter reading reaches zero, which is reached at point in time t=2.5·10⁻⁴ s. Graphs 66, 67, 68 provide comparison values for the respective generation of the control signals for the three phases. These were previously determined using the vector control described above. Corresponding control signals are then determined by comparing them with the values assigned to the respective phases according to graphs 66 to 68.

FIG. 9 shows a schematic diagram representation of the switching signals generated in this way using graphs 61, 62, 63. Graph 61 is assigned to graph 66 in FIG. 8, graph 62 is assigned to graph 67 according to FIG. 8, and graph 63 is assigned to graph 68 according to FIG. 8. The abscissa of the diagram according to FIG. 9 corresponds to the abscissa of the diagram according to FIG. 8. The ordinate is assigned to a relative switching state of the control signals, that is, only the values 0 and 1 are present, which are assumed by the control signals. It can be seen that the control signal according to graph 63 has the value 1 in a time range from a point in time t=0.25-10-4 s to a point in time t=2.25·10⁻⁴ s. Before and after its value is zero. A second control signal according to graph 62 is switched on for a period from a point in time t=0.625·10⁻⁴ s to a point in time t=1.875·10⁻⁴ s. Before and after its value is zero. In the present case, a switching signal according to graph 61 is switched on from point in time t=10⁻⁴ s until point in time 1.5·10⁻⁴ s. Before and after its value is zero.

Based on the control signals of graphs 61 to 63 determined in this way, the corresponding switching signals for the switching elements 11 to 16 are then generated by means of the control device 8, so that corresponding voltage curves are provided to the phase windings 42 of the stator winding connected to the inverter 36 in accordance with the control signals 61 to 63. As can be seen from FIGS. 8 and 9, the graph 69, that is, the counter reading at which the counting direction is changed, determines the operating clock rate. The values given result in a clock rate of approximately 4 kHz.

At point in time t=2.5·10⁻⁴ s the operating clock rate is changed. The maximum counter value at which the counting direction is changed is now approximately 9000. At the same time, adjusted values according to graphs 66 to 68 are determined by the control device 8 and used for the comparison with graph 69. As the second period or time segment marked with reference character 65 shows, this changes the period of the clock rate to 1.67·10⁻⁴ s, which corresponds to an operating frequency or operating clock rate of approximately 6 kHz. FIG. 9 shows in the corresponding area 65 the control signals generated in this way with the graphs 61 to 63. From this it can be clearly seen that the switching signals are correspondingly shorter in time.

In addition, further functionality can be provided, namely by sweeping the operating clock rate, as explained below. The sweeping is implemented here as discrete sweeping. As a result, among other things, conducted disturbance can be reduced. This development is based on the idea that frequency components of the operating clock rate or the operating frequency including harmonics and interharmonics with the fundamental oscillation based on the current operating rotational speed can be present in the frequency spectrum of the interference signals, especially at a constant clock rate. The operating clock rate or operating frequency can be varied according to the following Formula 4:

$${f}_{PWM} = {f}_{PWM\_Basis} ( 1 + 0.2 \cdot sin ( 2 \cdot φ ) )$$

In addition, further optimization can also be added, particularly with regard to a load or a load profile. For example, it can be provided that a ratio between a maximum and a currently existing torque is taken into account in order to reduce or limit a control range of sweeping under high loads. For example, maximum and minimum values can be introduced according to the following Equation 5:

$$\frac{{M}_{max}}{M} ∈ [ 1 , 3 ]$$

In addition, particularly when using a reciprocating piston compressor 21, an electrical rotor angle can be synchronized with the respective compression processes. An angle φ_{K} can result from an electrical rotor position and an offset. The offset can be selected such that a positive half-wave of a sine wave, which corresponds to a mechanical angle of 90° with respect to the number of pole pairs, lies essentially in a range of a compression cycle of the reciprocating piston compressor 21. The then higher operating clock rate can result in further advantages with regard to the control, in particular with regard to the torque ripple, a sampling rate and/or the like. For example, sweeping can be implemented according to the following Formula 6:

$${f}_{PWM} = {f}_{PWM\_Basis} \cdot ( 1 + 0 , 1 \cdot \frac{{M}_{max}}{M} \cdot sin ( 2 \cdot φκ )$$

FIG. 10 shows a further schematic diagram representation of the corresponding results. An abscissa of the diagram in FIG. 10 is assigned to the frequency in Hz and an ordinate to an interference level in dBμV. In FIG. 10, the standard limiting value for a quasi-peak interference according to the standard EN 55014/1 is shown with a graph 70. The standard limiting value for an average defined according to this standard is shown with a graph 71. A graph 74 shows the conducted disturbance in relation to graph 70 for a prior art constant operating clock rate control method. A corresponding mean value signal is shown in graph 78 in relation to graph 71. Graph 73 shows the conducted disturbance in the quasi-peak range for a control method if operational sweeping is also provided. A graph 77 shows the same for the mean value. It can be seen that the disturbances are more uniform compared to the prior art, i.e. their deflections are not too great. Graphs 72 and 76 show the corresponding relationships according to the invention based on variable operating clock rates, with graph 72 representing the quasi-peak value and graph 76 representing the average value. The reduction that can be achieved in terms of conducted disturbance is clearly visible.

The description of the figures serves exclusively to explain the invention and is not intended to limit it.

### LIST OF REFERENCE CHARACTERS

1 Household refrigeration appliance
2 Inner container
3 Interior
4 Door
5 Door rack
6 Shelves
7 Drawer
8 Control device
10 Carcass
11 Switching element
12 Switching element
13 Switching element
14 Switching element
15 Switching element
16 Switching element
17 DC link
18 Bridge rectifier
19 Energy supply network
20 Refrigerant circuit
21 Reciprocating piston compressor
22 Condenser
23 Flow restrictor
24 Evaporator
31 Compressor chamber
32 Inlet
33 Outlet
34 Piston
35 Connecting rod
36 AC voltage machine
37 Stator
38 Rotor
39 Volume
40 Energy supply
41 Inverter
42 Phase windings
43 Current sensor
44 Current sensor
45 Current sensor
46 Voltage sensor
49 Block
50 Block
51 Block
52 Block
53 Block
54 Block
55 Comparator
56 Reference unit
57 Comparator
58 Comparator
59 Block
60 Block
61 Graph
62 Graph
63 Graph
64 Period
65 Period
66 Graph
67 Graph
68 Graph
69 Graph
70 Graph
71 Graph
72 Graph
73 Graph
74 Graph
76 Graph
77 Graph
78 Graph
81 Graph
82 Graph
83 Graph
84 Graph
85 Graph

1-15. (canceled)

16. A method for operating an inverter electrically connected to a stator winding of an electrical AC voltage machine, the electrical AC voltage machine driving a component rotating at least intermittently about an axis of rotation in an intended operation of a household appliance, which method comprises the steps of:
applying, via the inverter, an electrical AC voltage to the stator winding, the electrical AC voltage being provided by means of at least one series circuit of the inverter having two switching elements, wherein the series circuit is supplied with a DC-link voltage;
generating switching signals for the switching elements by means of a controller of the inverter, wherein the controller determines the switching signals according to a pulse width modulation principle based on a clock rate in dependence on an operating signal for the component, wherein the clock rate is greater than a frequency corresponding to a rotational speed of the component;
determining an operating rotational speed of the component to be set in dependence on the operating signal, an operating clock rate is assigned to the operating rotational speed;
determining the switching signals based on the operating clock rate; and
setting the operating rotational speed of the component and the switching elements are acted upon by the switching signals based on the operating clock rate either before or only after the operating rotational speed has been set.

17. The method according to claim 16, which further comprises setting a maximum operating clock rate or the operating clock rate dependent on the operating rotational speed to be set during an acceleration process of the component.

18. The method according to claim 17, wherein the operating clock rate set before a braking process is maintained during the braking process of the component.

19. The method according to claim 18, wherein after the acceleration process or the braking process has ended, the operating clock rate is set in dependence on a current operating rotational speed.

20. The method according to claim 16, which further comprises determining the operating clock rate linearly and in dependence on the operating rotational speed.

21. The method according to claim 20, which further comprises choosing an integer ratio between the operating clock rate and the operating rotational speed.

22. The method according to claim 16, which further comprises changing the operating clock rate in dependence on a mechanical rotor position of a rotor of the electrical AC voltage machine.

23. The method according to claim 16, wherein the component has a reciprocating piston compressor and that the operating clock rate is changed outside of a compression stroke.

24. The method according to claim 16, wherein the operating clock rate is swept.

25. The method according to claim 24, wherein a sweeping covers a frequency range in which a maximum frequency value is at least 10% greater than an assigned operating clock rate and/or a minimum frequency value is at least 10% smaller than the assigned operating clock rate.

26. The method according to claim 25, wherein the component has a reciprocating piston compressor and the sweeping is synchronized with a compression process of the reciprocating piston compressor.

27. The method according to claim 25, wherein the sweeping takes place depending on a rotational position of the reciprocating piston compressor.

28. The method according to claim 24, wherein a sweeping covers a frequency range in which a maximum frequency value is at least 20% greater than an assigned operating clock rate and/or a minimum frequency value is at least 20% smaller than the assigned operating clock rate.

29. The method according to claim 24, wherein a sweeping covers a frequency range in which a maximum frequency value is at least 30% greater than an assigned operating clock rate and/or a minimum frequency value is at least 30% smaller than the assigned operating clock rate.

30. An inverter for applying an electrical AC voltage to a stator winding of an electrical AC voltage machine, wherein the stator winding is electrically connected to the inverter, and the electrical AC voltage machine drives a component rotating at least intermittently about an axis of rotation in an intended operation of a household appliance, the inverter comprising:
at least one series circuit having two switching elements for providing the electrical AC voltage; and
a controller for providing switching signals for said switching elements, wherein said at least one series circuit is supplied with a DC-link voltage (Udc), wherein said controller is configured to determine the switching signals according to a pulse width modulation principle based on a clock rate in dependence on an operating signal for the component, wherein the clock rate is greater than a frequency corresponding to a rotational speed of the component, wherein said controller is configured to determine an operating rotational speed of the component to be set in dependence on the operating signal, assigning an operating clock rate to the operating rotational speed, determining the switching signals based on the operating clock rate, setting the operating rotational speed of the component and applying the switching signals based on the operating clock rate to said switching elements either before or only after the operating rotational speed has been set.

31. The inverter according to claim 30, wherein said stator winding is configured as a multi-phase stator winding and said inverter system is configured to operate the multi-phase stator winding.

32. A household appliance, comprising:
a component rotating at least intermittently about an axis of rotation in an intended operation of the household appliance; and
an electrical AC voltage machine rotationally coupled to said component for rotatably driving said component, wherein said electrical AC voltage machine has a stator winding, and an inverter electrically connected to said stator winding for supplying said stator winding with an electrical AC voltage, said inverter is configured according to claim 30.
